(19) United States
(12) Patent Application Publication
(10) Pub. No.: US 2003/0105757 A1
(43) Pub. Date: Jun. 5, 2003

(54) Application service provider apparatus and method

(76) Inventor: Tushar Mangrola, Rancho Santa Margarita, CA (US)

Correspondence Address: Richard L. Myers, MYERS, DAWES & ANDRAS LLP, 19900 MacArthur Blvd., Suite 1150, Irvine, CA, 92612, US

(21) Appl. No.: 09/997,707

(22) Filed: Nov. 30, 2001

(51) Int. Cl. G06F 7/00

(52) U.S. Cl. 707/9

(57) ABSTRACT

An application server includes a directory responsive to multiple users from multiple companies to provide an indication of user identity, user role and user company. A single database stores data for each of the multiple companies. A container is responsive to the directory indication of user role to create a program, and is responsive to the directory indications of user identity and user company to provide the program with access to a particular portion of the data of the company in the database. An associated method for programming in an enterprise java bean protocol is based on information relating to the identity of a user, company of the user, and role of the user within the company. The method provides a plurality of application beans relating to different functions of the company and a database including data relating to different companies. A particular one of the application beans associated with the user role is selected, and the selected bean is programmed to access a particular portion of the database associated with the company of the user and the identity of the user.

### FILED OF THE INVENTION

This invention relates generally to computer hardware and software applicable to application service providers.

### BACKGROUND OF THE INVENTION

The maintenance of computer data is of concern to all users. For a single user, usually the capacity and operation of a desktop computer is sufficient for most data demands. For large users, large and expensive databases offering improved accessibility can usually be afforded. It is the medium size business which struggles with issues of size, operation and cost. In the past, application service providers (ASPs) accessible through the internet have used application servers to provide integrated applications such as business information, common knowledge and management systems, to medium size businesses. Database servers have been used to store user data for use in these applications. On such system in common use is that developed by Sun Microsystems, Inc. In this system, each application is referred to as a bean. Accessibility to these applications and the data has been facilitated by the internet infrastructure.

The cost of these ASP systems has been significant particularly for the small and medium size businesses. For each company, the ASP was required to have a dedicated application server that was hardwired or hard coded to a particular user database. Several users within the company would have access to the application server, but it was always understood that they were from the associated company because they came in on the only line input to the server, namely the line from the company. In these system interrogation of the user by the application server was limited solely to the identity and qualifications of the user. Ultimately each user was given access to particular applications which might include, for example, individual applications or beans relating to human resources, legal, shareholder services, shipping or accounting. Each user was identified with a particular role and his access to a particular application or bean was permitted only in accordance with that role. For example, a user having the role of a shipping clerk would only be permitted access to the shipping application or bean. On the other hand, an accountant might be permitted access not only to the accounting bean but also the shareholder application services bean. Thus, the only interrogation of user was made in an effort to identify that user with his role and designated applications associated with that role. Thus user authentication operated within a predetermined role security to provide a particular user with access only to the applications or beans associated with his role.

The beans provided general operating systems that might be applicable to all users having a common role. Thus the accounting bean might contain various equations of interest to any accountant regardless of his company. Feeding these application beans with the subjective data made that bean particularly applicable to a given individual and his company. The data or resources accessible by a particular bean could also be role-based depending on the authentication of a user. Thus, an accounts receiving clerk in the accounting department might be authenticated for access to the accounting bean but have the data available to him limited to the accounts receivable data.

At this point it is important to note that in the past each company had its own application service server which was accessible only by the users or employees of that company. The user merely logged in on the company line and was appropriately interrogated for access to a specific bean(s) and specific data contained in the company's database.

This architecture has proved to be particularly expensive as it has typically required a separate piece of hardware, namely a separate application server for each company. In some architectures, these separate application servers were hardwired or hard coded to a single database also associated with that company. This even further increased the cost of the architecture as it required a separate database server for each company.

More recently, database servers have been provided with a capacity for storing the data of more than one company. Firewalls were established between the data of different companies to provide a desired level of security. Notwithstanding this arcitecture which required only a single database for multiple companies, there still remained the requirement for a single application server for each company.

Within the application server a particular user's authentication gave him access to the applications or beans associated with his role. These beans, commonly referred to as master beans, were hard coded to a part database. Initially, an instantiated bean or clone was created for use by the user. This clone bean was activated and connected to the database providing that user with access to the relevant data. The clone bean and its connection to the database remained in memory as long as the user stayed online. When the user logged off, the clone bean and its access to the database were erased or passivated. As a result, substantial memory was required as there may be many companies needing a dedicated set of master beans. It was this requirement foreseen by the prior art and the teachings of the past that generated the common solution of providing a separate application server with a separate set of master beans for each company.

In the past, a separate database server has been required for each company. This is necessary not only to restrict the data of a particular company to its users, but also to inhibit those users from having access to the data of other companies. Accordingly, application service providers were required to have a single piece of database server. The cost of this architecture was passed on to the user and accordingly has made this solution particularly expensive at the user level.

### SUMMARY OF THE INVENTION

In accordance with the present invention, only a single application server is required for multiple companies. This server contains the same number of applications or beans available through the individual servers of the past. With only a single application server being required, there is a considerable savings in the amount of hardware needed by the application service provider. For example, he may need only a single application server for 100 companies rather than 100 application servers for 100 companies. This dramatic reduction in cost can be passed on to the ASP customers making the Internet infrastructure and sophisticated application beans available to all users at a greatly reduced cost.

Each user is coded not only with information consistent with his role, but also with information as to his particular company. This information is then used to select a particular master bean and to program that master bean prior to cloning or instantiation. Accordingly, the master bean is pre-programmed to connect to a particular database associated with the company of the particular user. This variable programming of the master bean is accomplished dynamically for each user prior to the creation of his clone or instantiated bean. The clone bean, with its appropriate database connection remains active in memory until the user logs off thereby passivating the clone bean.

With this system, the memory requirement of the application server is greatly reduced to a single set of master beans which are maintained permanently in memory, plus the clone beans which are passivated after each use. Thus only a single application server is needed to accommodate hundreds of companies and users. Instead of financing a separate application server, each company need only contribute nominally to a single application server at the application server provider.

These and other features and advantages of the invention will become more apparent with the description of preferred embodiments and reference to the associated drawings.

### DESCRIPTION OF THE DRAWINGS

FIG. 1 is a schematic view of an application server of the prior art accommodating a single company through an internet infrastructure;

FIG. 2 is a detailed schematic view of a directory, a master bean, resource locator, instantiated bean, and associated database as illustrated in FIG. 1;

FIG. 3 is a schematic view of an ASP adapted to accommodate more than one company in a first method of operation;

FIG. 4 is a schematic view of an ASP system adapted to accommodate more than one company in a second method of operation;

FIG. 5 is a schematic view of an ASP system adapted to accommodate more than one company in a further method of use;

FIG. 6 is a schematic view of an ASP system adapted to accommodate more than one company with a single set of application beans;

FIG. 7 is an enlarged view of the apparatus and method of FIG. 6 showing creation of an instantiated bean for the user of a first company; and

FIG. 8 is an enlarged view of the apparatus and method of FIG. 6 showing creation of a second instantiated bean for a user of a second company.

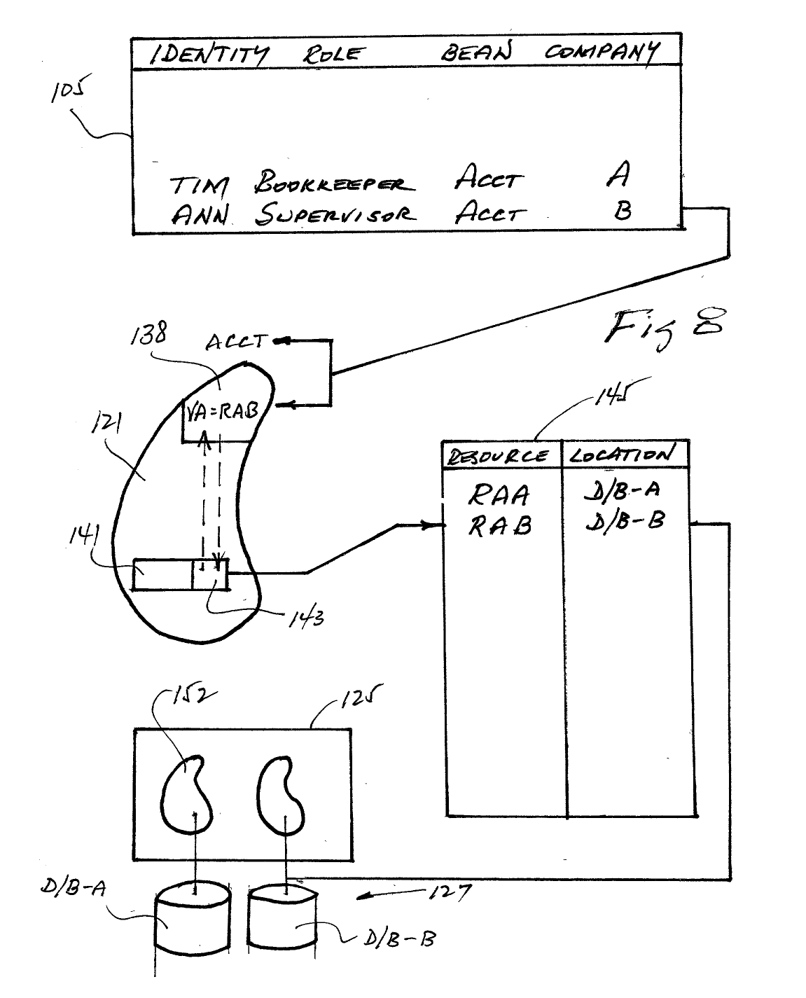

### DESCRIPTION OF PREFERRED EMBODIMENTS AND BEST MODE OF THE INVENTION

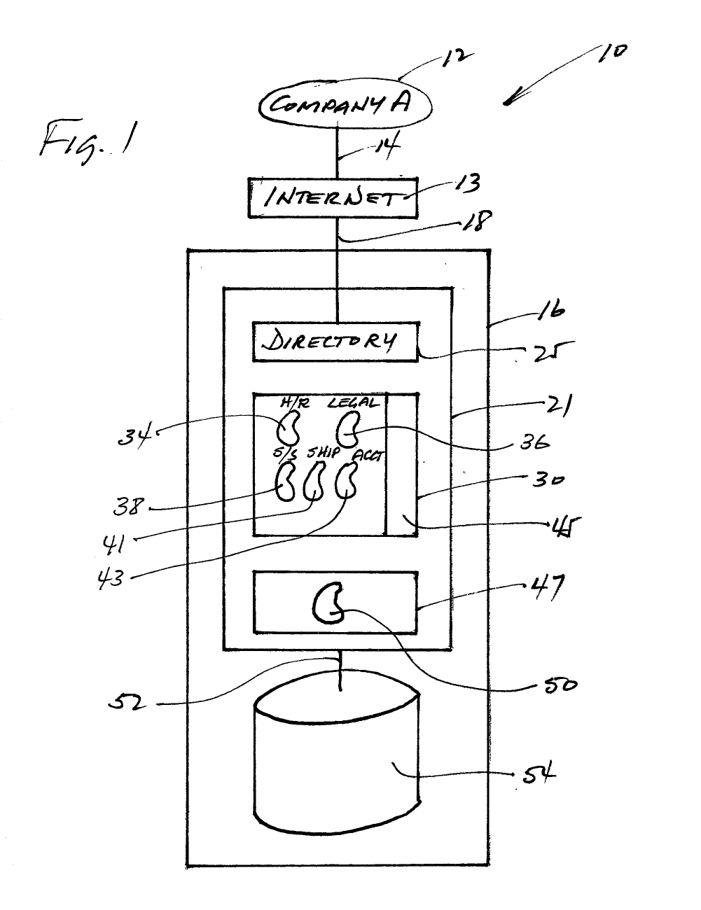

A computer application system of the prior art is illustrated in FIG. 1 and designated by the reference numeral 10. In accordance with this system, an individual (such as an employee), of a company (such as company A), would access an internet 12 through a telephone line 14. Through the associated internet infrastructure, an application service provider (ASP) 16 would be engaged through a communication link 18.

In the ASP 16, an application server 21 would be accessed on a line 23. Within the application server 21, a directory 25 monitors the log-on protocol of the individual or user 11. Within the directory, this protocol identifies the user, and importantly, his role within the company 12.

In this system 10, the directory 25 is coupled through a line 27 to a container 30 which stores multiple applications or programs 32 of interest to the company 12. A system commonly used for this purpose is referred to as Enterprise JavaBeans. In this system, the applications or programs 32 are referred to as master beans and are so illustrated in FIG. 1.

Applications which are typically of interest to the company 12 are represented in the container 30 by a human resources bean 34, a legal bean 36, a stockholders services bean 38, a shipping bean 41, and an accounting bean 43. Each of these master beans 32 contains one or more computer programs that might be of interest to that specific phase of the company's business. For example, the accounting bean 43 might include programs relating to accounts receivable/payable, financial reporting, and taxes.

These programs, of course, are meaningless in the absence of data relating to the company 12 which can be accessed and manipulated by operation of the particular beans 34-43. Thus, the remainder of the system is primarily involved in coupling the particular master bean of interest with the associated data of the company 12 in order to provide the user 11 with the information and computer tools appropriate to his role.

To that end, a resource locator 45 is included within the container 30 to couple the master bean of interest, such as the accounting bean 43 with the appropriate data. Once the appropriate data is designated, a copy or clone of the master bean, such as the bean 43, is made and stored in memory 47. This process is referred to as instantiation, and the cloned bean is referred to as an instantiated bean 50. In the memory 47, the instantiated bean 50 is coupled through a line 52 to the resource or database 54 designated by the resource locator 45. This process occurs substantially instantaneously, so that the user 11 has immediate access to the cloned bean 50 and the database 54 containing the data 56 associated with his company 12.

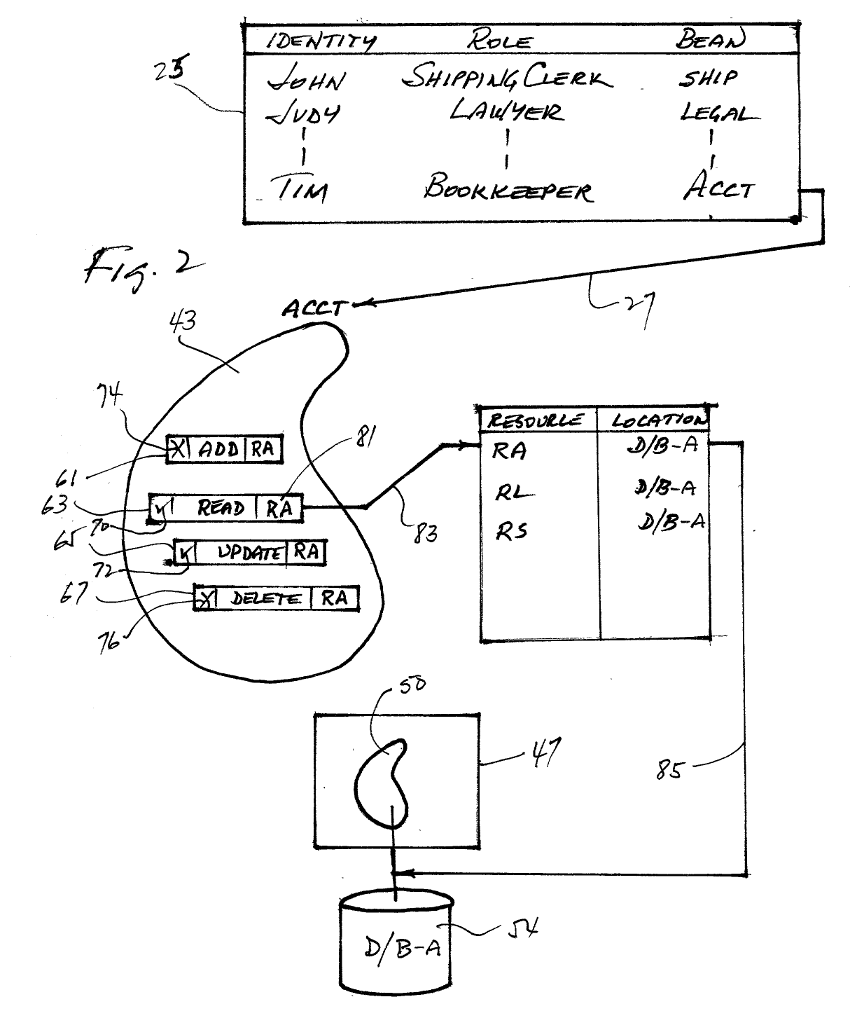

This system 10 is described in greater detail in FIG. 2 where the directory 25 is shown to contain the identity of various users, along with their respective roles and the particular bean or beans 32 to which each user 11 is permitted access. For example, in the illustrated case, the users 11 are identified as John, a shipping clerk having access to the ship bean 41; Judy, a lawyer having access to the legal bean 36; and Tim, a bookkeeper having access to the accounting bean 43. If Tim were the user 11 of the company 12, for example, the accounting bean 43 would be selected through the line 27.

This accounting bean 43 might typically include several matters which would enable the user 11 to perform functions such as “add”, “read”, “update”, and “delete”. These respective matters are illustrated in the bean 43 of FIG. 2 and designated by the reference numerals 61, 63, 65 and 67. Based on the role of the individual user 11, such as Tim, certain of these matters might be available such as the “read” matter 63 and the “update” matter 65. In FIG. 2, this access is designated by the check marks 70 and 72. However, based on Tim's role as a bookkeeper, his authority may not extend to the “add” matter 61 or the “delete” matter 67. This is indicated in FIG. 2 by the X marks 74 and 76.

Importantly, each of matters 61-67 has been hard-coded with a resource or data appropriate to the company 12. Thus, the “read” matter 63 might contain a resource designator 81 indicating that the “read” data is contained in resource A associated with company A. Through a line 83, the accounting bean 43 would look to the resource locator 45 for the location of the resource A.

As indicated by an arrow 83 in FIG. 2, the resource RA designated in the resource designator 81 is carried to the resource locator 45 which shows that the resource RA is located in the database A. Once this location of the resource is known to the master bean 43, the clone bean 50 can be instantiated in the memory 47 appropriately coupled to the database A pursuant to the location prescribed by the locator 45 on a line 85.

The problem with this system 10 relates to the hard-coding of the resource in the resource designator 81 of the beans 32, such as the bean 43. The only variable in this system is found in the resource locator 45 where the particular resources of company A are programmed to their specific locations. Thus, this system 10 of the past is said to be configured in the resource locator 45.

While the system of FIG. 1 has worked well for a single company 12, such as the company A, the system gets rapidly overwhelmed when more than one company is involved. For an ASP that has hundreds of client companies, the system has been very costly making it economically unavailable to small and medium sized companies.

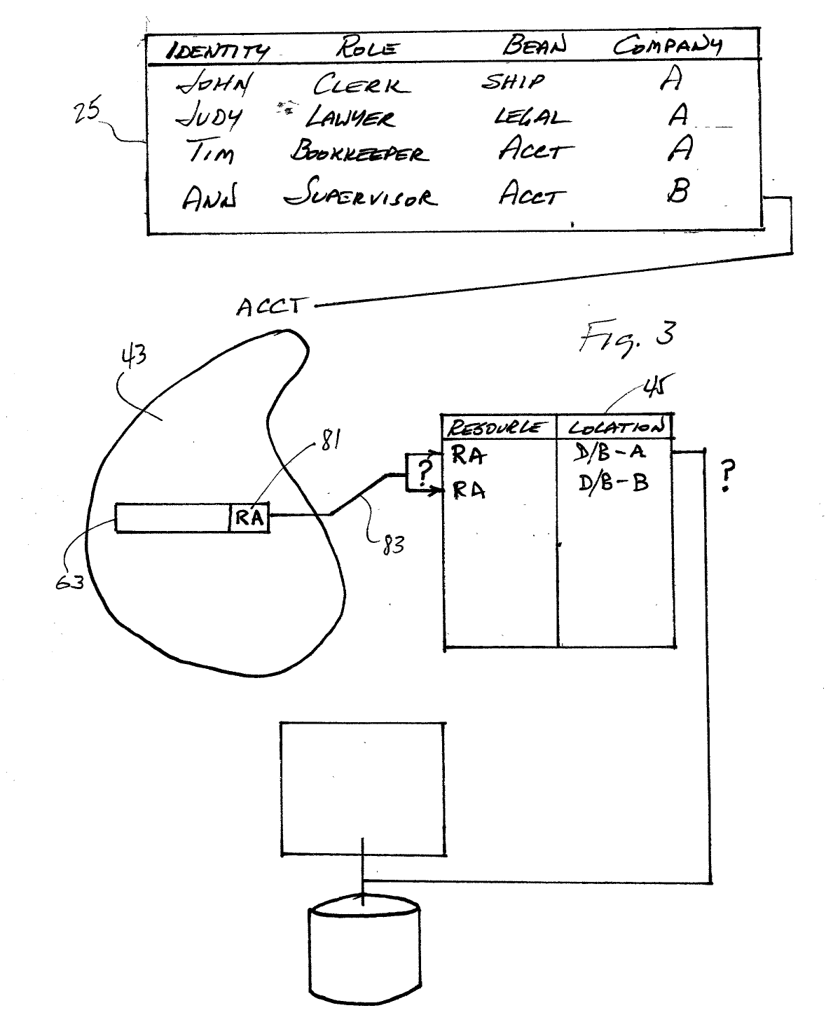

To further understand this complication, suppose that a second company B becomes a customer of the same ASP. Under this circumstance it would be easy to merely add a user 11 to the directory 25 as illustrated in FIG. 3. Thus, the directory 25 might be programmed to include an employee Ann who is an accounting supervisor in company B. Providing Ann with access to the accounting bean 43 would follow in the manner previously discussed. However, the complication arises with respect to the hard-coded resource found in the resource designator 81. In our example, the resource designator 81 is hard-coded to seek the resource RA. Looking to the resource locator 45, this resource RA was programmed to database A associated with company A. Following this resource designator into the locator 45 would connect master bean 43 to the database of company A. To accommodate Ann and her interest in the data of company B, a second line would need to be added to the resource locator 45, this line showing resource RA to be located in database B. To have two RA resources in the same locator 45 would create an error rendering this system inoperative for two separate companies.

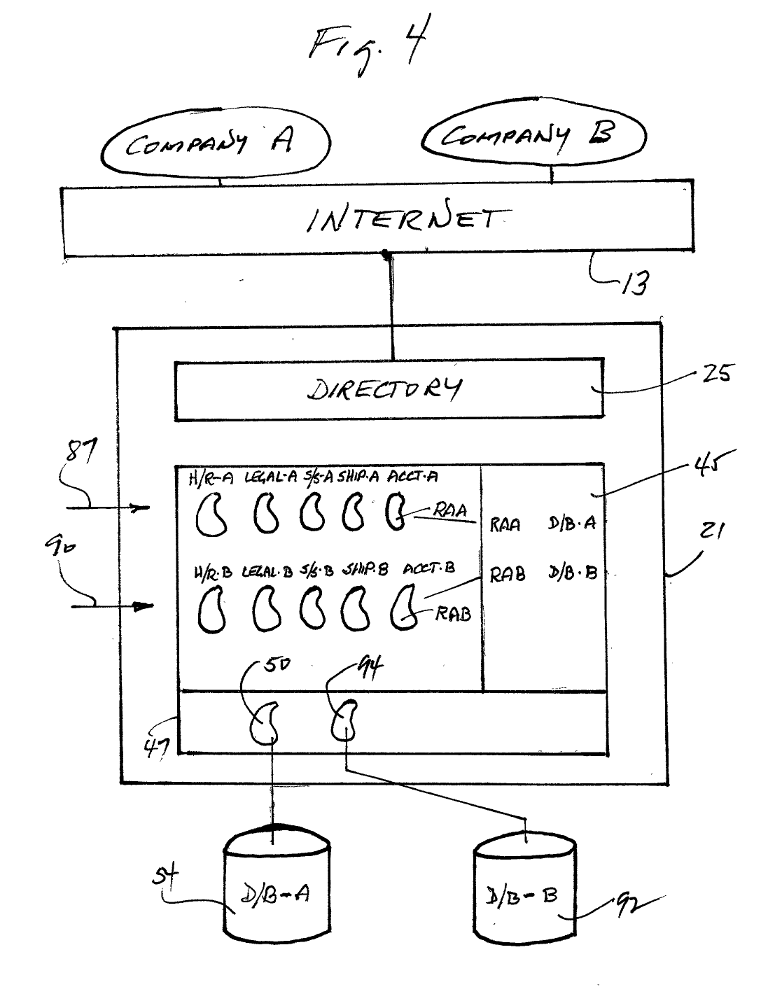

One solution to this problem is illustrated in FIG. 4 where the container 30 is provided with a complete series of the applications or beans 32 for each of the companies A and B. In FIG. 4, the series of beans associated with company A is shown by an arrow 87 while the series of beans associated with company B is shown by an arrow 93. Following the process of the prior art, each of the beans in the series 87 and 90 could be hard-coded with a resource appropriate to the company associated with the particular series 87 or 90. Thus, the accounting bean 43 for company A might be hard-coded RAA while the accounting bean 43′ for company B might be hard-coded with the resource RAB. With these two resources distinguished in the container 30, the resource locator 45 would merely be programmed to locate the respective resources RAA or RAB. Now, when Ann logs on, the accounting bean 43′ would be selected with its hard-coded designation of the resource RAB. Cloning of this master bean 43′ would result in coupling database B (designated by the reference numeral 92) to Ann's instantiated bean 94.

While this solution might work, it would be very costly since the application server 21 would require a very large memory 47 in order to store a full series of the applications or beans 32 for each of the companies. In the illustrated example wherein each series includes five applications, 100 companies or customers would require sufficient memory to store 500 of the applications 32. The required hardware would be exceedingly expensive rendering the process economically unavailable to small and medium sized users.

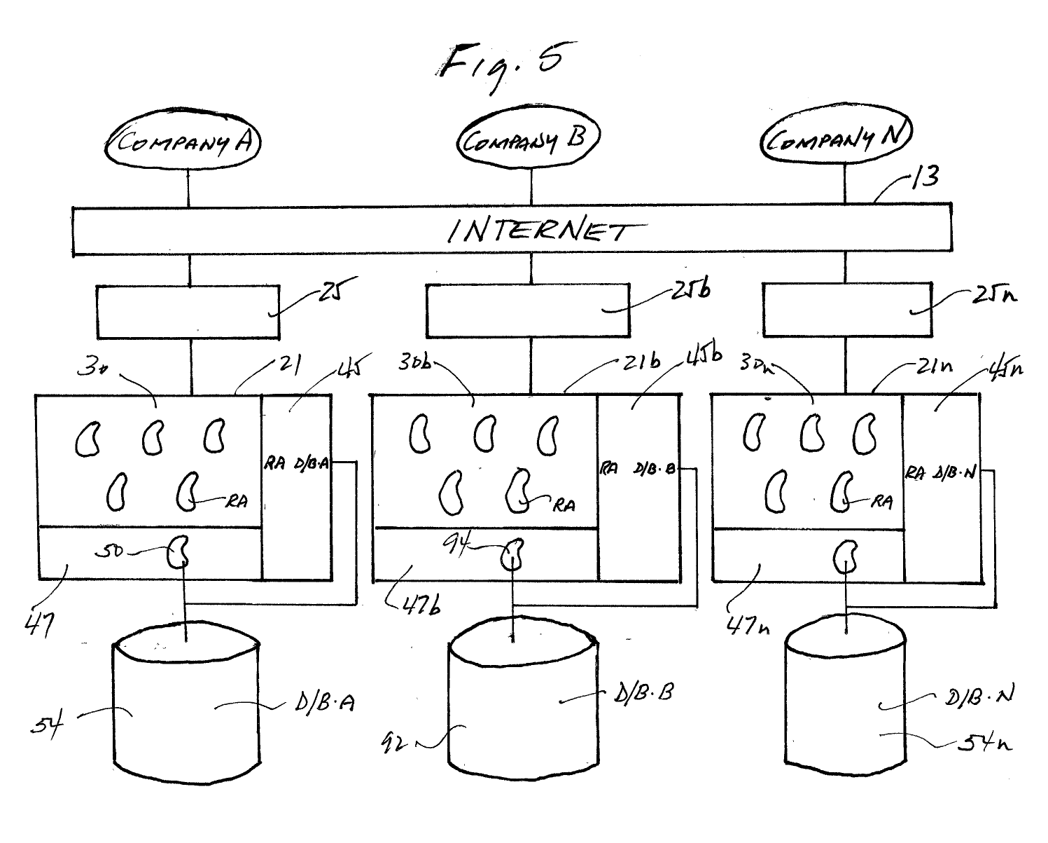

As an alternative, application service providers have typically duplicated the system of FIG. 1 for each of its companies. Such a system is illustrated generally in FIG. 5 where elements of structure similar to those previously discussed are designated with the same reference numeral followed by the lower case letter “b” for company b, and the lower case letter “n” for company N. Thus, in the past the ASP 16 was required to provide a separate application server 21 b and perhaps a separate database server 54b for the company B. In fact, for each of the companies accommodated by the ASP 16, a separate application server 21n and perhaps a separate database server 54n was required. It can be seen that the cost for the ASP to accommodate a single new company was the cost of a separate server 21n and perhaps a separate database server 54n. This cost of course was passed on to the new company and for many small and medium sized businesses represented a significant barrier to entry.

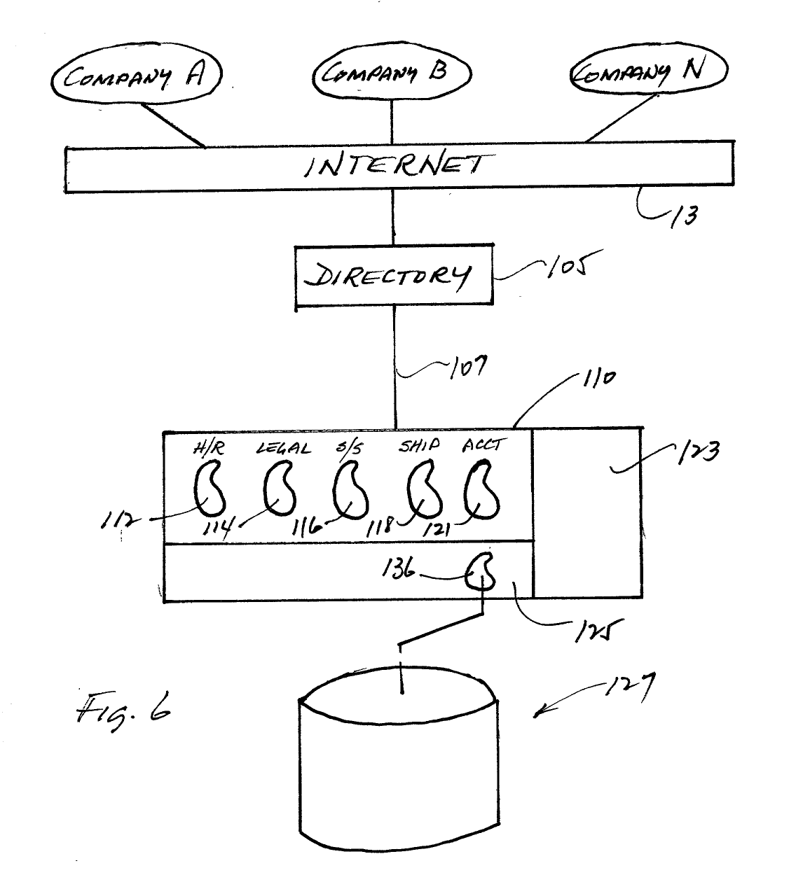

In one embodiment of the present invention, illustrated in FIG. 6, the three companies, A, B and N, are illustrated to have access through the internet 13 to an ASP 101. Within the ASP 101, a single application server 103 is provided with a directory 105 coupled through a line 107 to a container 110 having multiple beans such as a human resources bean 112, legal bean 114, stockholders services 116, shipping bean 118 and accounting bean 121. A resource locator 123 and memory 125 are provided in the manner previously discussed. The ASP 101 also includes a single database server 127 which might contain a database A, database B, and database N and an instantiated bean 136 illustrated in the memory 125.

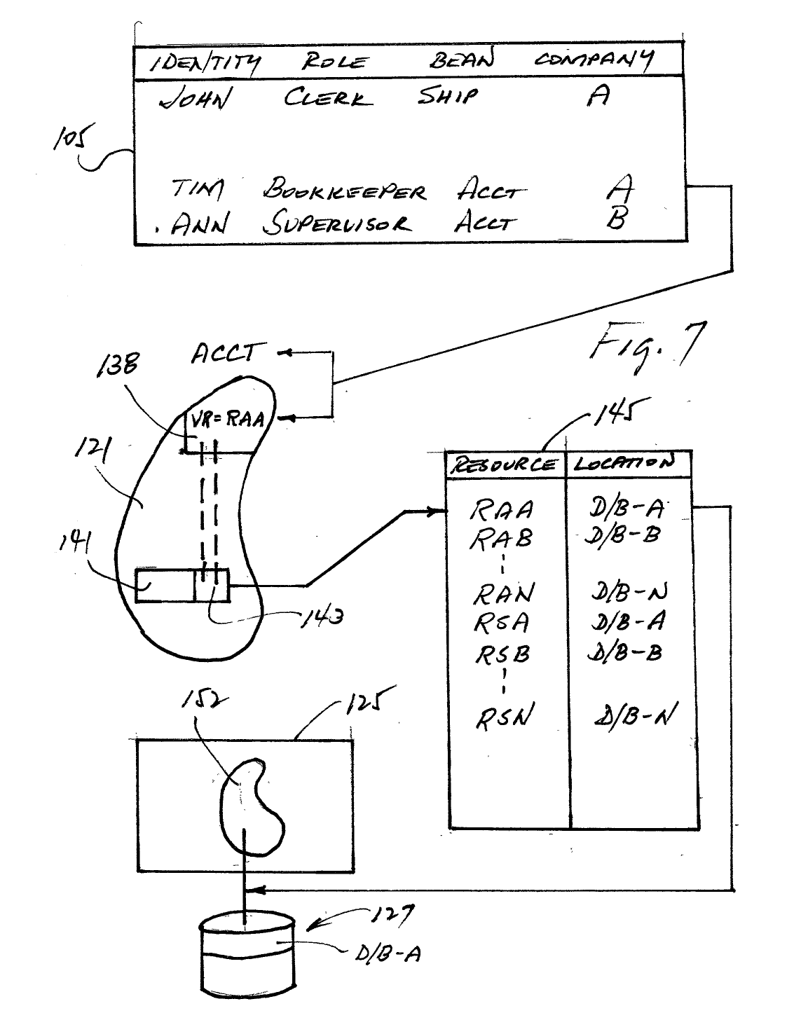

The details of this system are best illustrated in FIG. 7 wherein the master accounting bean 121 is shown to include a variable resource specifier 138. The master accounting bean 121 also includes a matter 141 having a resource designator 143. A resource locator 145 in this case includes data relating to all possible resource designators and their associated locations within the database server 127.

The directory 105 in this embodiment also differs from that of FIG. 1 in that it not only includes data related to identity, role and bean access, but also data related to the company associated with each user. Thus, the directory 105 in FIG. 7 might include Tim, the bookkeeper in company A as well as Ann, the accounting supervisor in company B.

In FIG. 7, it is assumed that Tim logs on to the directory 105 thereby gaining access to the accounting bean 121. With both the company A and the accounting bean designated in the directory 105, this information can be loaded into the variable resource specifier 138 with a resource appropriate not only to Tim's role as an accountant, but also his company. The matter 141 in the bean 121 is hard-coded to seek the variable designation in the resource specifier 138. Thus the connection designator 143 would look to the variable resource specifier 138 and designate the resource RAA for connection. Following this designation, the resource locator 145 would show that the resource RAA is located in database A. With this association made between the master bean 121 and the appropriate database A, Tim's bean could then be instantiated in the memory 125 with an appropriate connection to database A in the server 127. Tim's instantiated bean 136 will remain in the memory 125 until it is passivated and instantiated bean 152 will remain in the memory 125 until it is passivated pursuant to Tim's log-off.

It will be noted that in this system the resource locator will contain a considerable number of resources, for example, a number equal to the number of beans in the series times the number of companies accommodated by the ASP. But this single line of coding in the locator 145 is insignificant compared to an entire bean program required for each company in the embodiment of FIG. 4. Furthermore, only a single series of the application beans is required to accommodate all of the companies. Thus there is no duplication of the bean series such of that designated by the arrows 87 and 90 in FIG. 4. Only a single application server 103 and a single database server 127 is required to accommodate all of the customers and companies associated with the ASP 101.

The cost savings resulting from this considerable reduction in hardware can be passed on from the ASP 101 to the customers and companies. A new company desiring the services of the ASP will not be faced with the cost of additional hardware but only the cost of a minor program effort to add new employees to the directory 105 and to add a short series of resources to the locator 145.

A further advantage accrues to this system of FIG. 6 since each of the master beans 112-121 is used with all of the customer companies. If there is a desire to update or otherwise change the program associated with any of the beans, such as the shipping bean 118, this program can be changed in the master bean 118. Since the master bean serves all of the companies, the same change will occur in each of the cloned beans instantiated from that master bean. By comparison, in the system of FIG. 4, each of the master beans associated with a particular application would need to be reprogrammed for each of the companies. For 100 companies, 100 separate changes would be required for a single update. This would also apply to the system of FIG. 5 which required separate servers and separate beans for each of the companies.

It will be appreciated that in this disclosure, preferred embodiments have been discussed as examples of the underlying inventive concept. One is cautioned not to refer merely to these preferred embodiments in evaluating the extent of the concept, but rather encouraged to refer to the following claims to determine the scope of the invention.

1. A method for creating multiple user application programs using a single application server and a single database server, including the steps of:
storing user identification data including information relating to company user and user role;
providing the application server with a first application relating to a first user role and a second application relating to a second user role different that the first user role;
providing the single database server with first data relating to a first company and a first user, and second data relating to a second company and a second user;
responding to the information relating to user role to choose the first application;
responding to the information relating to company and user (identity) to choose the first data;
creating a first user application program from the first application and the first data; and
creating a second user application program from the second application and the second data.

2. The method recited in claim I further comprising the step of:
storing the first user application program and the second user application program in memory of the single application server.

3. The method recited in claim 1 wherein the storing step includes the steps of:
creating a directory responsive to user log-on data to provide the company, user identity and user role data.

4. The method recited in claim 3 wherein the creating step includes the step of:
programming the directory with subjective data relating to company, user identity and user role for each authorized user of the application server.

5. A method for programming in an enterprise java bean protocol based on information relating to identity of a user, company of the user, and role of the user within the company, comprising the steps of:
providing a plurality of application beans relating to different functions of the company;
providing the database including data relating to different companies;
selecting a particular one of the application beans associated with the user role;
programming the selected bean to access a particular portion of the database associated with the company of the user and the identity of the user.

6. The method recited in claim 5, further comprising the steps of:
providing a directory responsive to the user to indicate the user identity, the company of the user, and the role of the user;
during the selecting step, responding to the indication of the directory as to the role of the user to select the particular bean; and
during the programming step, responding to the indication of the directory as to the user identity and the company of the user, to program the bean to access the particular portion of the database.

7. The method recited in claim 6 further comprising the step of:
instantiating the programmed bean to create a clone bean adapted to access the particular portion of the database.

8. The method recited in claim 7 wherein the clone bean is a first clone bean, the portion of the database is a first portion, and the method further comprising the step of:
creating a second clone bean from the particular application bean, the second clone bean being adapted to access a second portion of the database different than the first portion of the database.

9. The method recited in claim 8 further comprising the step of:
storing the first clone bean and the second clone bean in memory.

10. An application server, comprising:
a directory responsive to multiple users from multiple companies to provide an indication of user identity, user role, and user company;
a single database storing data for each of the multiple companies;
a container responsive to the directory indication of user role to create a program; and
a container responsive to the directory indications of user identity, user role and user company to create a program and to provide the program with access to a particular portion of the data of the company in the database.

11. The application server recited in claim 10, wherein:
the container is responsive to the directory indication of user role to create the program; and
the container is responsive to the directory indication of user identity and company to provide the program with access to the particular portion of the data in the database.

12. A method for creating a first application program for a first user having a first user role in a first user company, and a second application program for a second user having a second user role in a second user company, comprising the steps of:
providing a single application server with multiple master programs;
providing a database server with data associated with multiple companies;
selecting a first one of the master programs based on the first user role;
selecting first data from the database, the first data being dependent on the first user identity and first user company; and
creating the first application program from the first master program and the first data;
selecting second data from the database, the second being dependent on the second user identity and second user company; and
creating the second application program from the second master program and the second data.

13. The method recited in claim 12, further comprising the steps of:
proving an Enterprise Java Bean Protocol in the application server wherein the multiple master programs comprise multiple master beans;
during the first selecting step selecting a first one of the beans based on the first user role; and
during the second selecting step, programming the first bean to access the first data.
